(19) United States
(12) Patent Application Publication
(10) Pub. No.: US 2026/0116206 A1
(43) Pub. Date: Apr. 30, 2026

(54) OVERMODULATION USING TRAPEZOIDAL CARRIER-BASED PULSE-WIDTH MODULATION IN ELECTRIFIED VEHICLES

(71) Applicant: FCA US LLC, Auburn Hills, MI (US)

(72) Inventor: Peter Azer, Auburn Hills, MI (US)

(21) Appl. No.: 18/932,918

(22) Filed: Oct. 31, 2024

(51) Int. Cl. B60L 15/02; B60L 15/08; B60L 50/51

(52) U.S. Cl. CPC B60L 15/025; B60L 15/08; B60L 50/51; B60L 2210/42; B60L 2240/423; B60L 2240/48; B60L 2240/527

(57) ABSTRACT

A control system for an electric motor of an electrified vehicle includes an inverter of the electrified vehicle, the inverter comprising a set of switches and being configured to receive three pulse-width modulation (PWM) signals and to control the set of switches to generate an alternating current (AC) output voltage from a direct current (DC) link voltage provided by a battery system of the electrified vehicle, and a control system configured to determine a torque command for the electric motor, determine commanded d-axis and q-axis voltages based on the torque command, generate a trapezoidal wave modulating signal for carrier-based PWM based on the commanded d-axis and q-axis voltages, generate the three PWM signals by performing carrier-based PWM using the trapezoidal wave modulating signal, and control the electric motor using the AC output voltage generated by the inverter.

### FIELD

The present application generally relates to electrified vehicles and, more particularly, to overmodulation carrier-based trapezoidal pulse-width modulation (PWM) in electrified vehicles.

### BACKGROUND

An electrified vehicle includes at least one electric motor configured to generate torque for vehicle propulsion. For a three-phase alternating current (AC) motor (e.g., a permanent magnet motor), direct current (DC) power is provided by a high voltage battery pack or system, which is then converted by an inverter into three phase AC power and used to control three windings of the electric motor. A modulation index of the inverter is defined as a ratio of an output line peak voltage (V_{m_line}) to the DC link voltage (V_{DC}). Space vector modulation (SVM) is one pulse-width modulation (PWM) motor control technique that is capable of achieving a modulation index of 1. By adding overmodulation, a higher modulation index (˜1.103) can be achieved, which can be used to increase motor torque output. SVM, however, is difficult and costly to implement. Accordingly, while such conventional motor control techniques do work for their intended purpose, there exists an opportunity for improvement in the relevant art.

### SUMMARY

According to one example aspect of the invention, a control system for an electric motor of an electrified vehicle is presented. In one exemplary implementation, the control system comprises an inverter of the electrified vehicle, the inverter comprising a set of switches and being configured to receive three pulse-width modulation (PWM) signals and to control the set of switches to generate an alternating current (AC) output voltage from a direct current (DC) link voltage provided by a battery system of the electrified vehicle and a control system configured to determine a torque command for the electric motor, determine commanded d-axis and q-axis voltages based on the torque command, generate a trapezoidal wave modulating signal for carrier-based PWM based on the commanded d-axis and q-axis voltages, generate the three PWM signals by performing carrier-based PWM using the trapezoidal wave modulating signal, and control the electric motor using the AC output voltage generated by the inverter.

In some implementations, the trapezoidal wave modulating signal is capable of achieving a modulation index for the inverter of greater than one. In some implementations, the control system is further configured to determine a magnitude of the trapezoidal wave modulating signal by calculating:

$${V}_{m \_ line} = \sqrt{3} \times \sqrt{{v}_{d}^{2} + {v}_{q}^{2}} , \qquad ( 1 )$$

where V_{m_line} represents an output line peak voltage and v_{d} and v_{q} represent the commanded d-axis and q-axis voltages, respectively. In some implementations, the control system is further configured to determine the modulation index for the inverter by calculating:

$${m}_{a} = \frac{{V}_{m \_ line}}{{V}_{D C}} , \qquad ( 2 )$$

where V_{DC} represents the DC link voltage.

In some implementations, the control system is further configured to estimate the magnitude of the trapezoidal wave modulating signal by determining:

$$Ta = f ( {m}_{a} ) , \qquad ( 3 )$$

where Ta represents a constant value period of the trapezoidal wave modulating signal, mₐ represents the modulation index, and f represents a function or relationship between the constant value period Ta and the modulation index. In some implementations, the function or relationship f is a one-dimensional lookup table (LUT) relating various values of the modulation index mₐ to various values of a ratio (Ta/T), where T represents a total period of the trapezoidal wave modulating signal. In some implementations, the function or relationship f is a non-linear relationship between the modulation index mₐ and the ratio (Ta/T).

In some implementations, the control system is further configured to determine an angle or phase (φ) of the trapezoidal wave modulating signal by calculating:

$$φ = \frac{π}{2} - \frac{π}{2} sign ( {v}_{d} ) + ( {tan}^{- 1} \vert \frac{{v}_{d}}{{v}_{q}} \vert ) sign ( {v}_{d} \times {v}_{q} ) , \qquad ( 4 )$$

where v_{d} and v_{q} represent the commanded d-axis and q-axis voltages, respectively, and sign determines a sign of a respective variable. In some implementations, the control system is further configured to compare, for each of the three phases, the trapezoidal wave modulating signal to the carrier signal to determine the respective PWM signal. In some implementations, the carrier signal is a triangular wave signal.

According to another example aspect of the invention, a control method for an electric motor of an electrified vehicle is presented. In one exemplary implementation, the control method comprises providing an inverter of the electrified vehicle, the inverter comprising a set of switches and being configured to receive three PWM signals and to control the set of switches to generate an AC output voltage from a DC link voltage provided by a battery system of the electrified vehicle, determining, by a control system of the electrified vehicle, a torque command for the electric motor, determining, by the control system, commanded d-axis and q-axis voltages based on the torque command, generating, by the control system, a trapezoidal wave modulating signal for carrier-based PWM based on the commanded d-axis and q-axis voltages, generating, by the control system, the three PWM signals by performing carrier-based PWM using the trapezoidal wave modulating signal, and controlling, by the control system, the electric motor using the AC output voltage generated by the inverter.

In some implementations, the trapezoidal wave modulating signal is capable of achieving a modulation index for the inverter of greater than one. In some implementations, the control method further comprises determining, by the control system, a magnitude of the trapezoidal wave modulating signal by calculating:

$${V}_{m\_line} = \sqrt{3} \times \sqrt{{v}_{d}^{2} + {v}_{q}^{2}} , \qquad ( 1 )$$

where V_{m_line} represents an output line peak voltage and v_{d} and v_{q} represent the commanded d-axis and q-axis voltages, respectively. In some implementations, the control method further comprises determining, by the control system, the modulation index for the inverter by calculating:

$${m}_{a} = \frac{{V}_{m\_line}}{{V}_{DC}} , \qquad ( 2 )$$

where V_{DC} represents the DC link voltage.

In some implementations, the control method further comprises estimating, by the control system, the magnitude of the trapezoidal wave modulating signal by determining:

$$Ta = f ( {m}_{a} ) , \qquad ( 3 )$$

where Ta represents a constant value period of the trapezoidal wave modulating signal, mₐ represents the modulation index, and f represents a function or relationship between the constant value period Ta and the modulation index. In some implementations, the function or relationship f is a one-dimensional LUT relating various values of the modulation index mₐ to various values of a ratio (Ta/T), where T represents a total period of the trapezoidal wave modulating signal. In some implementations, the function or relationship f is a non-linear relationship between the modulation index mₐ and the ratio (Ta/T).

In some implementations, the control method further comprises determining, by the control system, an angle or phase (φ) of the trapezoidal wave modulating signal by calculating:

$$φ = \frac{π}{2} - \frac{π}{2} sign ( {v}_{d} ) + ( {tan}^{- 1} \vert \frac{{v}_{d}}{{v}_{q}} \vert ) sign ( {v}_{d} \times {v}_{q} ) , \qquad ( 4 )$$

where v_{d} and v_{q} represent the commanded d-axis and q-axis voltages, respectively, and sign determines a sign of a respective variable. In some implementations, the control method further comprises comparing, by the control system and for each of the three phases, the trapezoidal wave modulating signal to the carrier signal to determine the respective PWM signal. In some implementations, the carrier signal is a triangular wave signal.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a plot of an example carrier-based trapezoidal pulse-width modulation (PWM) including a trapezoidal wave modulating signal and a triangular carrier wave according to the principles of the present application;

FIG. 2 is a functional block diagram of an electrified vehicle having an electric motor and an example control system therefor according to the principles of the present application;

FIG. 3 is a plot of an example trapezoidal wave modulating signal and its variable magnitude and phase according to the principles of the present application;

FIGS. 4A-4B and 5A-5D are plots of example determinations of the magnitude of the trapezoidal wave modulating signal according to the principles of the present application;

FIG. 6 is a plot of an example determination of the phase of the trapezoidal wave modulating signal according to the principles of the present application;

FIG. 7 is a functional block diagram of an example system architecture for the control system according to the principles of the present application; and

FIG. 8 is a flow diagram of an example control method for an electric motor of an electrified vehicle according to the principles of the present application.

### DESCRIPTION

As previously discussed, space vector modulation (SVM) is one pulse-width modulation (PWM) motor control technique that is capable of achieving a modulation index of 1. By adding overmodulation, a higher modulation index (˜1.103) can be achieved, which can be used to increase motor torque output. SVM, however, is difficult and costly to implement. More specifically, SVM involves commanding one of six different inverter states. In contrast to SVM, carrier-based sinusoidal PWM is much simpler and less costly. This technique involves using a carrier signal (e.g., a triangular wave) and a modulating signal (e.g., the desired alternating current, or AC output voltage) to control the switching (on/off states) of switches/transistors of the inverter to ensure that the output voltage of the inverter follows a desired waveform (e.g., a sinusoid). Conventional carrier-based sinusoidal PWM techniques, however, are limited to a lesser modulation index (˜0.866). One overmodulation technique for carrier-based sinusoidal PWM techniques is harmonic injection, but this only increases the modulation index to 1.

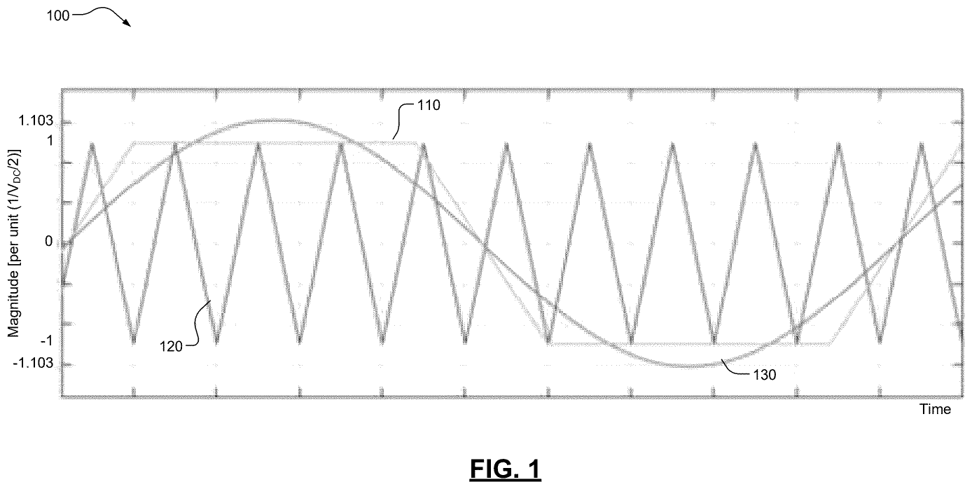

Accordingly, a carrier-based trapezoidal PWM technique is presented herein. As explained more fully herein, this carrier-based trapezoidal PWM technique is capable of achieving the higher modulation index (˜1.103) achievable by SVM with overmodulation. As shown in the plot 100 of FIG. 1, the carrier-based trapezoidal PWM has a trapezoidal wave modulating signal 110 with a triangular carrier wave 120, which results in a fundamental component 130 of the phase voltage having the desired peak magnitude (˜1.103). A frequency of the trapezoidal wave modulating signal 110 corresponds to the inverter fundamental frequency and a frequency of the carrier wave 120 corresponds to the inverter switching frequency. The magnitude/phase of the trapezoidal wave modulating signal 110 are determined from the commanded direct and quadrature (dq) voltages. In application, the carrier-based trapezoidal PWM technique is utilized to generate the PWM signals for controlling three legs of an inverter for generating the three AC phase voltages for the respective windings of an electric motor of an electrified vehicle.

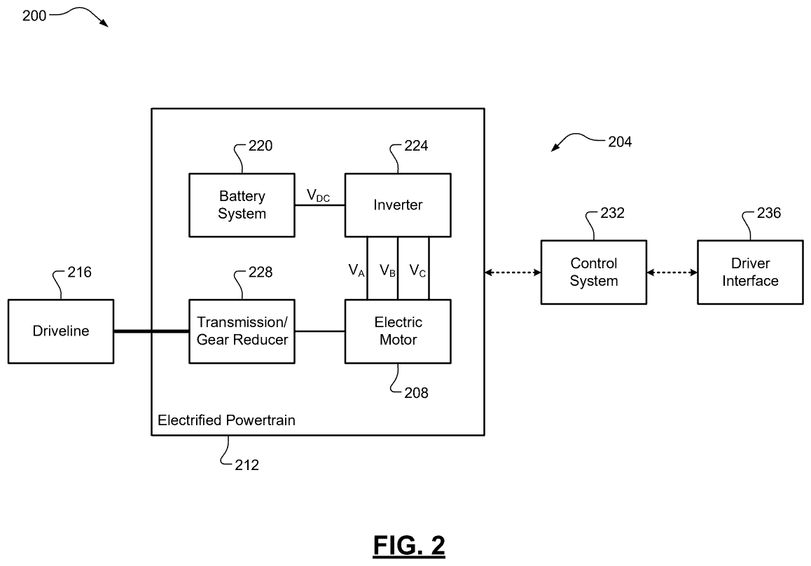

Referring now to FIG. 2, a functional block diagram of an electrified vehicle 200 including an electric motor 208 and an example control system 204 therefor according to the principles of the present application is illustrated. The electrified vehicle 200 comprises an electrified powertrain 212 that is configured to generate and transfer drive torque to a driveline 216 for propulsion. As shown, the electrified powertrain 212 comprises the electric motor 208, a high voltage battery pack or system 220, an inverter 224, and a transmission or gear reducer 228. While one electric motor 208 and inverter 224 are shown, it will be appreciated that the electrified powertrain 208 could include multiple electric motors/inverters, as well as other optional components, such as a secondary power source (an internal combustion engine, a fuel cell system, etc.). In one exemplary implementation, the electric motor 208 is a three-phase AC motor (e.g., a permanent magnet motor) that is powered by three phase voltages V_{A}, V_{B}, V_{C} generated by the inverter 224. The inverter 224 (e.g., a full-bridge rectifier) comprises three switching bridges or legs that are configured to generate these three phase voltages V_{A}, V_{B}, V_{C} (e.g., collectively forming one AC voltage waveform) from a DC link voltage (V_{DC}) output by the battery system 220.

The optional transmission or gear reducer 228 is configured to transfer (e.g., multiply) the drive torque from the electric motor 208 to a final drive ratio at the driveline 216. The electrified vehicle 200 is controlled by a controller or control system 232. The control system 232, for example, could include a plurality of electronic control units (ECUs) connected to each other via a controller area network (CAN). For example only, the control system 232 could include a supervisory controller, such as an electrified vehicle control unit (EVCU) or hybrid control processor (HCP), and secondary controllers, such as a motor control processor (MCP) and a battery pack control module (BPCM). One primary function of the control system 232 is to control the electrified powertrain 208 to generate a desired amount of drive torque to satisfy a driver torque request, which could be provided via a driver of the electrified vehicle 200 via a driver interface 236 (e.g., an accelerator pedal). While not explicitly shown, it will be appreciated that the electrified vehicle 200 could further include other sensors/actuators.

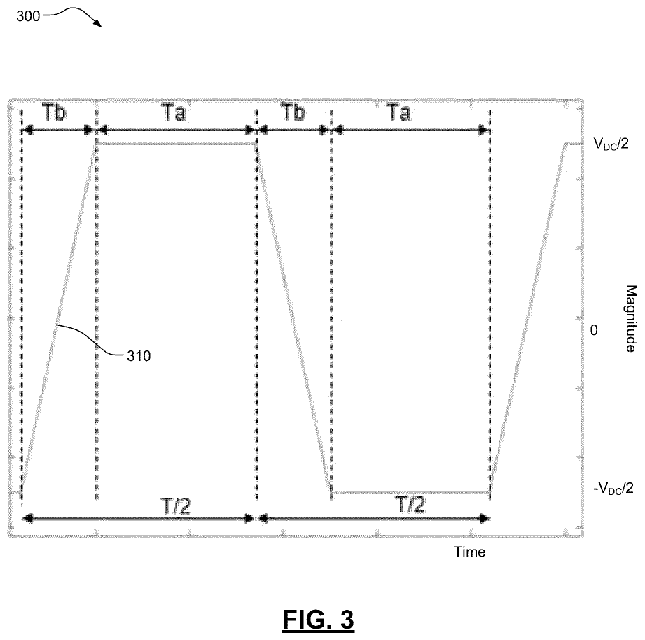

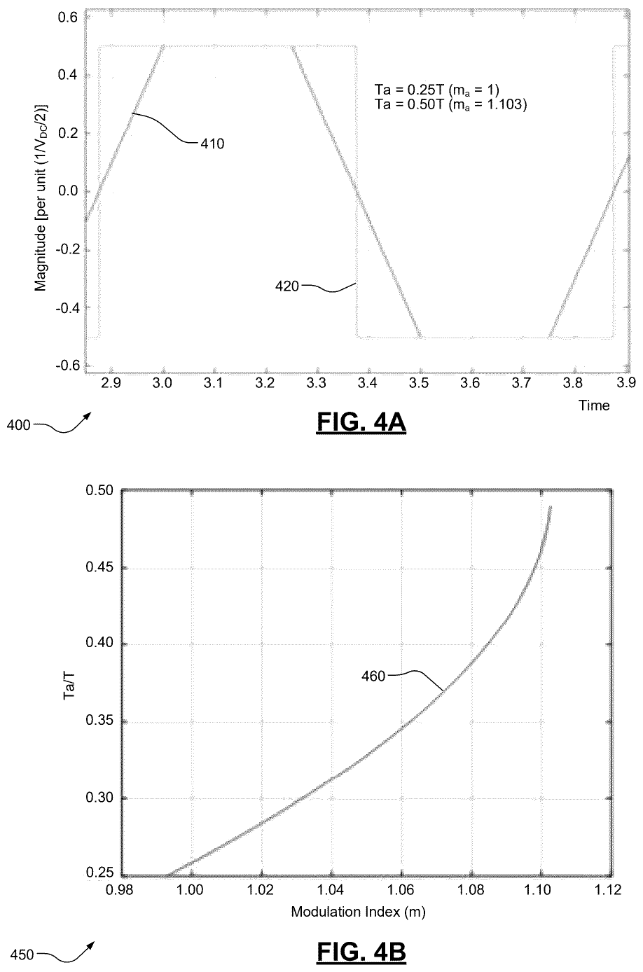

Referring now to FIGS. 3 and 4A-4B and with continued reference to the previous figures, plots 300, 400, and 450 of an example trapezoidal wave modulating signal and its variable magnitude and phase according to the principles of the present application is illustrated. As shown in FIG. 3, the trapezoidal wave modulating signal 310 is symmetrical. That is, each period (T) of the trapezoidal wave modulating signal 310 includes both constant value portions (V_{DC}/2 or −V_{DC}/2) and sloped straight lines. The constant value portions corresponds to period Ta, and the sloped straight line portions corresponds to period Tb. The summation of Ta and Tb (Ta+Tb) equals one half of the total period T. T is also the reciprocal of the fundamental frequency (f=1/T). FIGS. 4A-4B further illustrate plots 400, 450 for determination of the magnitude of the trapezoidal wave modulating signal. As shown in FIG. 4A, the trapezoidal wave modulating signal can vary from Ta=Tb=0.25T (line 410), which has a modulation index (mₐ) of 1, to Ta=0.50T and Tb=0 (line 420), which has a modulation index mₐ of 1.103. In other words, the minimum value of Ta is 0.25T, which results in the unity modulation index (mₐ=1), and the maximum value of Ta is 0.50T, which results in the maximum modulation index (mₐ=1.103), which is equivalent to the six-step operation of SVM. Therebetween (0.25T<Ta<0.50T), the modulation index mₐ varies non-linearly as shown in plot 450 of FIG. 4B (see line 460). This relationship between Ta/T and the modulation index mₐ could be saved, for example, in a one-dimensional look-up table (LUT).

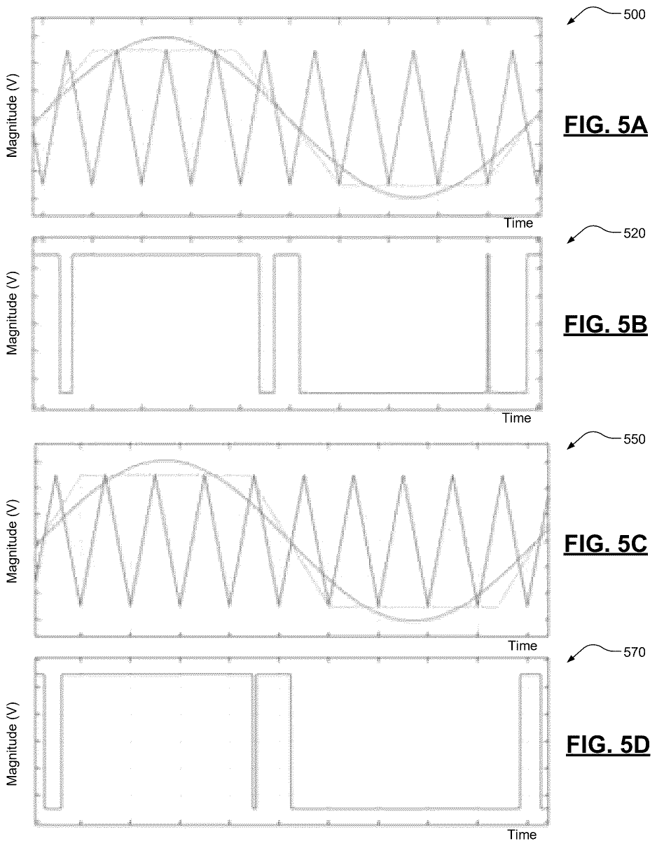

Referring now to FIGS. 5A-5D and with continued reference to the previous figures, plots 500, 520, 550, and 570 of two example determinations of the magnitude of the trapezoidal wave modulating signal according to the principles of the present application are illustrated. For a given dq command (d-axis voltage v_{d} and q-axis voltage v_{q}), a peak line voltage (V_{m_line}) is calculated, then a modulation index mₐ is calculated, and then Ta is estimated or calculated using the above-described one-dimensional LUT. For example, these calculations could be as follows:

$${V}_{m\_line} = \sqrt{3} \times \sqrt{{v}_{d}^{2} + {v}_{q}^{2}} , \qquad ( 1 )$$

$${m}_{a} = \frac{{V}_{m\_line}}{{V}_{DC}} , and \qquad ( 2 )$$

$${T}_{a} = f ( {m}_{a} ) , \qquad ( 3 )$$

where f represents the function of FIG. 4B or the one-dimensional LUT. In the example determination of FIG. 5A, the modulation index mₐ is calculated to be 1.03 and the period Ta is determined to be 0.29T, which results in the inverter phase voltage waveform as shown in FIG. 5B. Similarly, in the example determination of FIG. 5C, the modulation index mₐ is calculated to be 1.06 and the period Ta is determined to be 0.36T, which results in the inverter phase voltage waveform as shown in FIG. 5D.

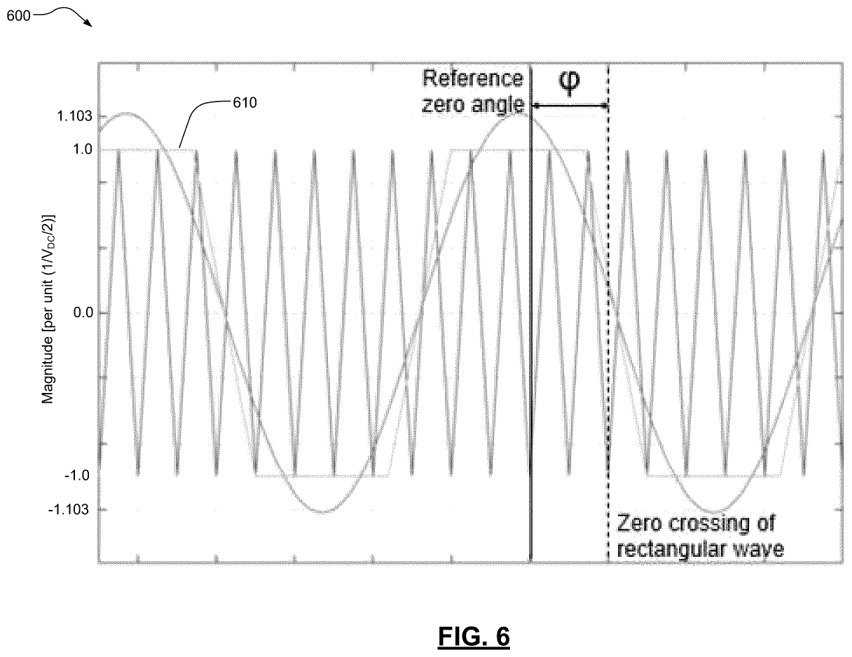

Referring now to FIG. 6 and with continued reference to the previous figures, a plot 600 of an example determination of the phase of the trapezoidal wave modulating signal 610 according to the principles of the present application is illustrated. The positive zero-crossing of the trapezoidal wave modulating signal 610 and the fundamental phase voltage component are the same. Thus, by controlling the angle (φ) of the trapezoidal wave modulating signal 610, the angle of the fundamental phase voltage is controlled:

$$φ = \frac{π}{2} - \frac{π}{2} sign ( {v}_{d} ) + ( {tan}^{- 1} \vert \frac{{v}_{d}}{{v}_{q}} \vert ) sign ( {v}_{d} \times {v}_{q} ) , \qquad ( 4 )$$

where sign determines the sign of the variable. Thus, the phase or angle φ of the trapezoidal wave modulating signal 610 can be determined (based on the dq command, or v_{d} and v_{q}) using the above-described equation/relationship.

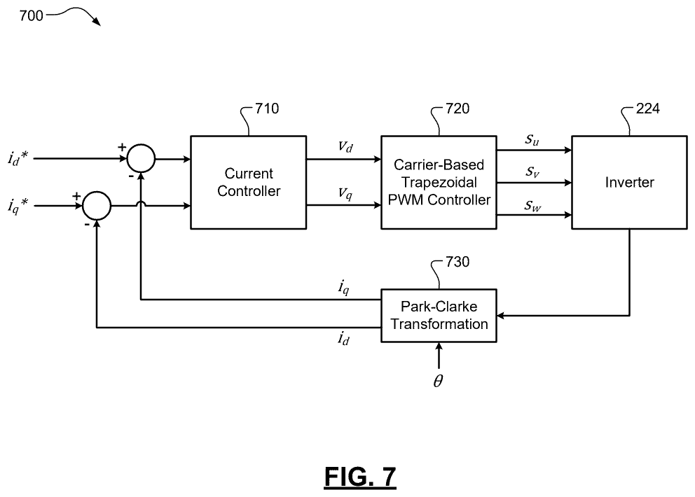

Referring now to FIG. 7 and with continued reference to the previous figures, a functional block diagram of an example system architecture 700 for the control system 132 according to the principles of the present application is illustrated. In FIG. 7A, a current controller 710 receives a dq current command (commanded d-axis current i_{d}* and commanded q-axis current i_{q}*) corresponding to a driver torque request for the electric motor 208. Based on these values and feedback (i_{d} and i_{q}) determines the dq voltage command (the d-axis voltage v_{d} and the q-axis voltage v_{q}) and outputs these values to a carrier-based trapezoidal PWM controller 720. This block 720 generates PWM signals (sᵤ, sᵥ, and s_{w}) based on the commanded d-axis voltage v_{d} and the q-axis voltage v_{q} and outputs these values to the inverter 224. The steps or calculations performed by block 720 include those previously-described herein, including calculating a desired magnitude of the trapezoidal modulating signal Ta by calculating a desired modulation index mₐ based on a ratio of the desired output line peak voltage (V_{m_line}) to the DC link voltage V_{DC} and applying the function f or one-dimensional LUT to determine the desired magnitude Ta of the trapezoidal wave modulating signal (e.g., using Equations 1-3).

The steps of calculations performed by block 720 also include determining the desired angle (q) for the trapezoidal wave modulating signal as previously-described herein (e.g., using Equation 4). Finally, block 720 generates the PWM signals sᵤ, sᵥ, s_{w} for phases u, v, and w by comparing each phase's trapezoidal wave modulating signal to the carrier signal and, when the modulating signal is greater than the carrier signal, the respective PWM signal is one, and otherwise (i.e., when the modulating signal is less than the carrier signal), the respective PWM signal is zero. The inverter 224 uses these PWM signals sᵤ, sᵥ, s_{w} to control its switches/transistors such that it outputs a desired AC voltage (e.g., a sinusoid) having a desired modulation index mₐ for achieving the desired motor torque. The phase currents iᵤ, iᵥ, and i_{w} (collectively, i_{uvw}) are returned as feedback and converted back to the dq domain by a Park-Clarke transformation 730 (based further on an instantaneous angle θ if an arbitrary φ frequency) to provide the feedback d-axis and q-axis currents i_{d} and i_{q}, respectively, which are compared (i.e., subtract) from the commanded d-axis and q-axis currents i_{d}* and i_{q}*, respectively, and then used to determine the dq voltage command.

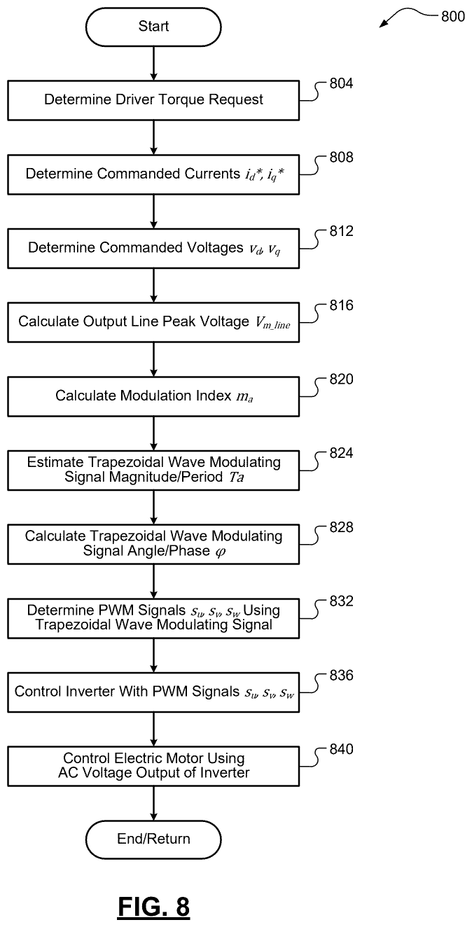

Referring now to FIG. 8, a flow diagram of an example control method 800 for an electric motor of an electrified vehicle according to the principles of the present application is illustrated. While the method 800 specifically references the electrified vehicle 100 and its components, it will be appreciated that the method 800 could be applicable to other suitably configured electrified vehicles, as well as non-vehicle power conversion applications. The method 800 begins at 804 where the control system 132 receives a driver torque request via the driver interface 136. At 808, the control system 132 determines a dq current command (i_{d}* and i_{q}*) based on the driver torque request and other parameters of the electrified powertrain 212. At 812, the control system 132 determines a dq voltage command (v_{d} and v_{q}) based on the dq current command and current feedback (i_{d} and i_{q}). At 816, the control system 132 determines a desired output line peak voltage V_{m_line} based on the d-axis and q-axis voltages v_{d} and v_{q}, respectively. At 820, the control system 132 determines the desired modulation index mₐ as a ratio of the desired output line peak voltage V_{m_line} to the DC link voltage V_{DC}.

At 824, the control system 132 determines the desired magnitude Ta for the trapezoidal wave modulating signal based on the function/relationship f or using the corresponding one-dimensional LUT. At 828, the control system 132 determines the desired phase φ for the trapezoidal wave modulating signal based on the d-axis and q-axis voltages v_{d} and v_{q}, respectively. At 832, the control system 132 determines the three PWM phase signals sᵤ, sᵥ, and s_{w} based on a comparison between the respective phase trapezoidal wave modulating signals and the carrier signal. At 836, the control system 132 controls the inverter 224 using the three PWM phase signals sᵤ, sᵥ, and s_{w} to achieve the desired AC output voltage (e.g., a sinusoid), which is then used to control the electric motor 208 at 840 to achieve the torque request. The method 800 then ends or returns to 804 for one or more additional cycles.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A control system for an electric motor of an electrified vehicle, the control system comprising:
an inverter of the electrified vehicle, the inverter comprising a set of switches and being configured to receive three pulse-width modulation (PWM) signals and to control the set of switches to generate an alternating current (AC) output voltage from a direct current (DC) link voltage provided by a battery system of the electrified vehicle; and
a control system configured to:
determine a torque command for the electric motor;
determine commanded d-axis and q-axis voltages based on the torque command;
generate a trapezoidal wave modulating signal for carrier-based PWM based on the commanded d-axis and q-axis voltages;
generate the three PWM signals by performing carrier-based PWM using the trapezoidal wave modulating signal; and
control the electric motor using the AC output voltage generated by the inverter.

2. The control system of claim 1, wherein the trapezoidal wave modulating signal is capable of achieving a modulation index for the inverter of greater than one.

3. The control system of claim 2, wherein the control system is further configured to determine a magnitude of the trapezoidal wave modulating signal by calculating:
$${V}_{m\_line} = \sqrt{3} \times \sqrt{{v}_{d}^{2} + {v}_{q}^{2}} , \qquad ( 1 )$$
where V_{m_line} represents an output line peak voltage and v_{d} and v_{q} represent the commanded d-axis and q-axis voltages, respectively.

4. The control system of claim 3, wherein the control system is further configured to determine the modulation index for the inverter by calculating:
$${m}_{a} = \frac{{V}_{m\_line}}{{V}_{DC}} , \qquad ( 2 )$$
where V_{DC} represents the DC link voltage.

5. The control system of claim 4, wherein the control system is further configured to estimate the magnitude of the trapezoidal wave modulating signal by determining:
$$Ta = f ( {m}_{a} ) , \qquad ( 3 )$$
where Ta represents a constant value period of the trapezoidal wave modulating signal, mₐ represents the modulation index, and f represents a function or relationship between the constant value period Ta and the modulation index.

6. The control system of claim 5, wherein the function or relationship f is a one-dimensional lookup table (LUT) relating various values of the modulation index mₐ to various values of a ratio (Ta/T), where T represents a total period of the trapezoidal wave modulating signal.

7. The control system of claim 6, wherein the function or relationship f is a non-linear relationship between the modulation index mₐ and the ratio (Ta/T).

8. The control system of claim 2, wherein the control system is further configured to determine an angle or phase (φ) of the trapezoidal wave modulating signal by calculating:
$$φ = \frac{π}{2} - \frac{π}{2} sign ( {v}_{d} ) + ( {tan}^{- 1} \vert \frac{{v}_{d}}{{v}_{q}} \vert ) sign ( {v}_{d} \times {v}_{q} ) , \qquad ( 4 )$$
where v_{d} and v_{q} represent the commanded d-axis and q-axis voltages, respectively, and sign determines a sign of a respective variable.

9. The control system of claim 2, wherein the control system is further configured to compare, for each of the three phases, the trapezoidal wave modulating signal to the carrier signal to determine the respective PWM signal.

10. The control system of claim 9, wherein the carrier signal is a triangular wave signal.

11. A control method for an electric motor of an electrified vehicle, the control method comprising:
providing an inverter of the electrified vehicle, the inverter comprising a set of switches and being configured to receive three pulse-width modulation (PWM) signals and to control the set of switches to generate an alternating current (AC) output voltage from a direct current (DC) link voltage provided by a battery system of the electrified vehicle;
determining, by a control system of the electrified vehicle, a torque command for the electric motor;
determining, by the control system, commanded d-axis and q-axis voltages based on the torque command;
generating, by the control system, a trapezoidal wave modulating signal for carrier-based PWM based on the commanded d-axis and q-axis voltages;
generating, by the control system, the three PWM signals by performing carrier-based PWM using the trapezoidal wave modulating signal; and
controlling, by the control system, the electric motor using the AC output voltage generated by the inverter.

12. The control method of claim 11, wherein the trapezoidal wave modulating signal is capable of achieving a modulation index for the inverter of greater than one.

13. The control method of claim 12, further comprising determining, by the control system, a magnitude of the trapezoidal wave modulating signal by calculating:
$${V}_{m\_line} = \sqrt{3} \times \sqrt{{v}_{d}^{2} + {v}_{q}^{2}} , \qquad ( 1 )$$
where V_{m_line} represents an output line peak voltage and v_{d} and v_{q} represent the commanded d-axis and q-axis voltages, respectively.

14. The control method of claim 13, further comprising determining, by the control system, the modulation index for the inverter by calculating:
$${m}_{a} = \frac{{V}_{m\_line}}{{V}_{DC}} , \qquad ( 2 )$$
where V_{DC} represents the DC link voltage.

15. The control method of claim 14, further comprising estimating, by the control system, the magnitude of the trapezoidal wave modulating signal by determining:
$$Ta = f ( {m}_{a} ) , \qquad ( 3 )$$
where Ta represents a constant value period of the trapezoidal wave modulating signal, mₐ represents the modulation index, and f represents a function or relationship between the constant value period Ta and the modulation index.

16. The control method of claim 15, wherein the function or relationship f is a one-dimensional lookup table (LUT) relating various values of the modulation index mₐ to various values of a ratio (Ta/T), where T represents a total period of the trapezoidal wave modulating signal.

17. The control method of claim 16, wherein the function or relationship f is a non-linear relationship between the modulation index mₐ and the ratio (Ta/T).

18. The control method of claim 12, further comprising determining, by the control system, an angle or phase (φ) of the trapezoidal wave modulating signal by calculating:
$$φ = \frac{π}{2} - \frac{π}{2} sign ( {v}_{d} ) + ( {tan}^{- 1} \vert \frac{{v}_{d}}{{v}_{q}} \vert ) sign ( {v}_{d} \times {v}_{q} ) , \qquad ( 4 )$$
where v_{d} and v_{q} represent the commanded d-axis and q-axis voltages, respectively, and sign determines a sign of a respective variable.

19. The control method of claim 12, further comprising comparing, by the control system and for each of the three phases, the trapezoidal wave modulating signal to the carrier signal to determine the respective PWM signal.

20. The control method of claim 19, wherein the carrier signal is a triangular wave signal.
